(19) United States
(12) Patent Application Publication
(10) Pub. No.: US 2020/0217980 A1
(43) Pub. Date: Jul. 9, 2020

(54) METHOD AND VESSEL STEERING MODULE FOR SEISMIC DATA ACQUIRING AND FOR ROUTING A VESSEL

(71) Applicant: POLARCUS SHIPHOLDING AS, Oslo (NO)

(72) Inventor: Gary WINFIELD, Dubai (AE)

(21) Appl. No.: 16/635,579

(22) PCT Filed: Aug. 7, 2018
(86) PCT No.: PCT/NO2018/050203

§ 371 Date: Jan. 31, 2020

(30) Foreign Application Priority Data
Aug. 8, 2017 (NO) 20171320

(51) Int. Cl. G01V 1/38; B63B 21/66

(52) U.S. Cl. CPC G01V 1/3808; B63B 21/66; G01V 1/3861; G01V 1/3826

(57) ABSTRACT

Method for acquiring seismic data by generating a first straight line (2) drawn from a starting point (3) to an end point (4), then generating a number of offset straight lines (6), each being placed perpendicular to the first straight line (2) and ending in a second point (7) in a distance X from the first straight line (2). The second points (7) provide an array of cross track offset values providing a survey line (10). A vessel steering module is described adapted to send command information to a vessel steering system. The invention also concerns use of the module for performing the method.

The present invention relates to a method for acquiring seismic data in a marine environment and for routing a vessel from a starting point to an end point, the vessel is towing seismic sources generating acoustic pulses and seismic receivers mounted to, or inserted in streamers in the water following behind the vessel, whereby a survey of a marine environment area is generated.

The invention also relates to a vessel steering module for a seismic integrated navigation system adapted to send command information to a vessel steering system.

Marine seismic exploration is used to investigate and map the structures and character of subsurface geological formations underlying a body of water. Marine seismic data is typically gathered by towing seismic sources—e.g. air guns and seismic receivers such as hydrophones—through a body of water behind one or more marine vessels. When the seismic sources and receivers are towed through the water, the seismic sources generate acoustic pulses that travel through the water and into the earth, where they are reflected. The seismic receivers sense the resulting reflected energy, thereby acquiring seismic data that provides information about the geological formations underlying the body of water.

The use of repeated surveys adds a time dimension to the data set. This is termed “Four-dimensional seismology” or “4D surveying”. In a typical marine survey, up to 20 streamer cables and one or more sources are towed behind a vessel. A typical streamer includes many sensors positioned at spaced intervals along its length, which can typically range from 2 to 12 km. The streamer cables are typically positioned from 25 to 150 meters apart. They are preferably towed in a generally parallel relationship to collect survey data over a uniform sampling grid.

The citations U.S. Pat. Nos. 8,891,331, 8,891,332, 7,415,936, 9,052,411 and 9,157,746 all relate to seismic data collection such as different survey steering methods for controlling a vessel or for controlling a source.

U.S. Pat. No. 8,391,102 relates to a system and method for automatic steering of a marine seismic towing vessel. The system comprises a towing vessel, a seismic source, and one or more seismic streamers towed by the towing vessel. It further comprises a steering sub-system for steering the vessel, the sub-system includes vessel steering algorithm for calculating an optimum vessel steering path, and a controller to produce a difference between measured positions of a tracking point with a pre-plot position of the tracking point. It then calculates a set point based on the difference to the steering algorithm.

However, the system and the method require, that the vessel has to make adjustments to try to follow a path with regularly changing heading. This changing heading message sent from an integrated navigation system (INS) to a vessel steering system causes the system to behave sub-optimally as the desired track azimuth/survey line is often and irregularly changing.

Further, typical seismic steering “autopilots” (e.g. Robtrack, KPOS) are designed to facilitate the seismic vessel and are adapted to let the towed array follow a straight path between two waypoints (the start and end of the seismic survey line).

This makes the steering systems of the vessel less appropriate for following a survey line, which has changing heading/azimuth as is typical the case of the so-called 4D seismic line.

With other words, it is desirable to be able to provide a simplified desired survey path and on the other hand, that the desired survey path is easy to transfer to an algorithm whereby predicted desired offsets are communicated to a steering system of the vessel. This allows the vessel to follow the predicted path, especially when the survey line has a changing heading/azimuth. This is specially the case when carrying out a 4D survey. However, the invention is also applicable for 3D and 2D survey.

The present invention seeks generally to improve a seismic steering method and a vessel steering module such that the abovementioned insufficiencies and drawbacks of today's seismic steering methods and steering modules are overcome or at least it provides a useful alternative.

Up to this day, prior art has failed to teach a simple and yet reliable seismic steering method and module which in a safe and reliable manner, without substantially increasing the cost of the device, is able to satisfy the abovementioned much desired characteristics of the mentioned seismic steering method and module.

According to the invention, a method is provided, as per the introductory part of this specification, and wherein the method comprises
generating a first straight line drawn from the starting point to the end point,
then generating a number of offset straight lines, each offset line being placed perpendicular to the first straight line and each starting in a first point placed on the first straight line and ending in a second point in a distance X from the first straight line,
said second points providing an array of cross track offset values providing a survey line when connected continuous to each other,
said vessel is navigating substantially using the track offset values and substantially following the survey line.

Further, a vessel steering module is provided, as per the introductory part of this specification, and wherein the command information is provided by data comprising
determine the end-points of a baseline and use that to determine a desired first straight line between those points being a starting point and an end point,
generating a number of offset straight lines, each offset line being placed perpendicular to the first straight line, and each starting in a first point placed on the first line and ending in a second point in a distance from the first straight line,
determine the lateral and perpendicular distance between the first straight line—derived in the previous step—and the second point,
said second points derived from previous acoustic pulses generated by a previous survey of the same area, and second points adapted to be desired points for generating new acoustic pulses,
store the parameters from the step above in an array or in a file for use by the vessel steering system, when acquiring a non-straight and curved survey line.

When performing a 4D survey, the desire is to replicate what occurred in a survey that was acquired as a set of 3D survey lines. Instead of having a straight baseline path that is the case for a 3D survey line, the invention provides a new survey line, which is made up of a non-straight line path between the end points of the survey line/the first straight line. In this way the survey line is provided, and the steering of the vessel is optimized. The survey line is provided by a straight line from which a set of desired lateral offsets (positive and negative offsets relating to starboard and port relative to the straight line path) are provided, and the end points of each lateral offset is the path which the vessel is going to follow.

The array of cross track offset values are calculated based on the shot-points/acoustic pulses generated during a previous survey. These acoustic pulses are referred to as previous acoustic pulses or baseline shot-points. The pulses generated during the new survey are referred to as new acoustic pulses or monitor shot-points.

The desired track of the vessel and/or the towed equipment of the vessel is by the invention represented by a constant azimuth line/curved line between the two end waypoints: the starting point, and the endpoint of the first straight line.

According to one embodiment, the continuous connection-line between the array of cross track offset values provides an oscillating survey line arranged alternately on one side and on the other side of the straight line, or arranged on one side of the first straight line.

The oscillating path could for instance be a substantially sinusoidal continuous curve, the top-points of the sinus curve located alternately on one side and on the other side of the first straight line or on the same side. The top points are typically placed with different distances to the first straight line.

According to one embodiment, the array of cross track offset values are derived or calculated based on parameters for where and when acoustic pulses from a previous survey of the same area have been triggered, and that the acoustic pulses during the present survey are intended to be triggered, when the tow vessel following the array of cross track offset values or a towed equipment are substantially reaching such a cross track offset value.

The intention is that the vessel follows the curved line. However, in reality the shot may take place as the vessel traverses along the line irrespective of whether it successfully follows the curved path or not. Any deviation between the desired curved path and the real path of the vessel would be a “cross track error”. The vessel steering module then provides a correction. The shots are carried out with a direction substantially parallel with the first straight line.

According to one embodiment, a deviation between the position of the tow vessel and the cross track offset values is overcome by changing the routing of the vessel by manual steering exercised by a user and automatically by an output to a steering system.

An integrated navigation system would determine the desired offset values for heading the vessel or its towed equipment for the segment of the survey line the vessel is currently traversing. This forms part of an output to a steering system.

Due to local environmental conditions at the time, the user has the option to apply a correction to the cross track offset value (for example a strong current induces a “crab” of the vessel and it's towed gear).

Therefore, the final value for the track offset value sent from the INS to a seismic steering system would be the sum of the machine-derived offset for the survey line at that location, and any user defined correction based on local environmental conditions at the time.

According to one embodiment, look-ahead cross track offset values are generated based on a set of parameters for modelling a desired steering behaviour, the parameters comprise data such as
registering the length L of a streamer,
registering the distance of the sources from the vessel,
and the distance of the streamers from the vessel,
said parameters are used to compute a look-ahead time or a look-ahead distance value, said values are used by a vessel steering system.

This look-ahead value is a way to compensate for the delay between the vessel passing a shot point with its desired “track offset” and the towed equipment passing the same shot point.

For example, assuming that the towed source array is 225 meters behind the vessel.

If there is 25 m between shot points on the survey line, then 225 meters equates to 9 shot points.

Therefore, the look-ahead value could be arranged to output the desired cross track offset to the seismic tracking module 9 shots before the vessel or the towed equipment reaches that shot point, thereby allowing the vessel to induce steering commands, and cause the towed source to reach the desired lateral offset value.

The look-ahead value (time or distance calculated) would be chosen to best match the combination (sum) of any steering delays and the distance from the vessel to the relevant part of the towed equipment.

This look-ahead value might change from survey to survey, or even potentially from line to line based on the real world behaviour of the vessel and towed gear system in those environmental conditions.

The invention also concerns a vessel steering module as claimed in claim 6

According to one embodiment, the steering module further provides data comprising data for the shortest distance between the starting point and the end point, the velocity of the towing vessel along the shortest distance and the velocity of the towing vessel following the heading provided by the curved survey line.

According to one embodiment, the steering module is further adapted to receive user-values said user-values are corrections to the cross track offset of the vessel based on local environments conditions

According to one embodiment, the vessel steering module is a separate module being an interface between the vessel steering module and another system such as a bridge control system.

According to one embodiment, the vessel steering module is an integrated part of the seismic integrated navigation system.

According to one embodiment, the method and the vessel steering module is applicable for a Four-dimensional seismological survey.

According to one embodiment, the method and the vessel steering module is applicable for a 3D seismological survey.

The invention also relates to use of the vessel steering module according to the description ad as claimed to exercise the method according to the description and as claimed.

### BRIEF DESCRIPTION OF THE DRAWINGS

FIG. 1 is a principal drawing of a reference line and lines for providing a survey line according to the invention.

FIG. 2 is a principal drawing of a tow vessel following the movement and survey line, the shooting direction and time for providing acoustic pulses, using the principles shown in FIG. 1.

FIG. 3 is a detailed view of a part of the oscillating survey line and the position of a vessel.

FIG. 4 is a detailed view of a part of the oscillating survey line and the position of a vessel.

FIG. 5 is a detailed view of a part of the oscillating survey line and the position of a vessel.

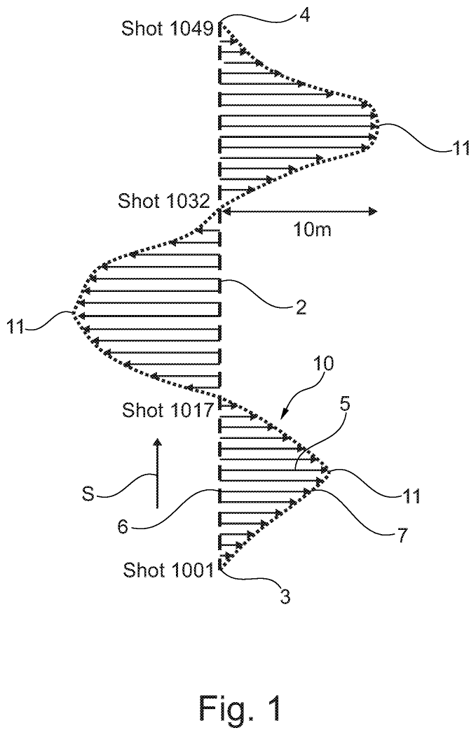

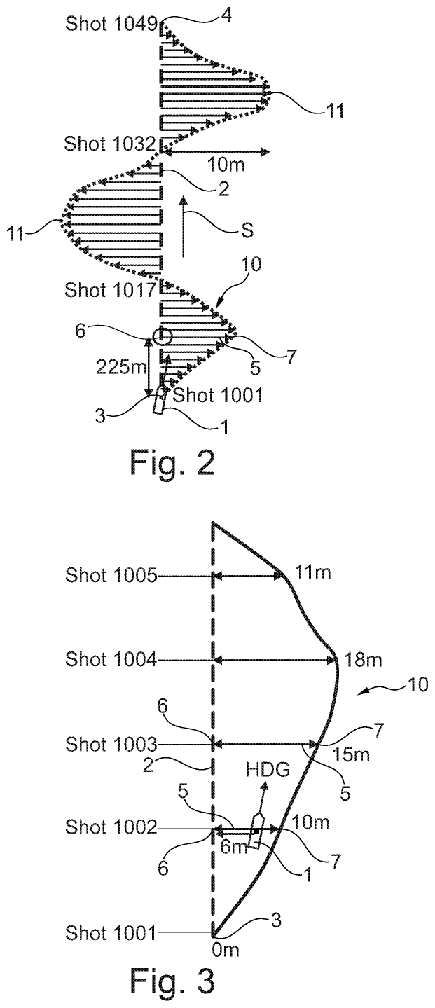

The invention will be explained with reference to FIG. 1 and FIG. 2. FIGS. 1 and 2 showing a principal drawing of a reference line 2 and a desired vessel movement line 10 according to the invention and the shaping of the movement line of a vessel 1. FIG. 2 also shows the position of the vessel 1, and it discloses when the shooting/acoustic pulses are taking place. The straight line path 2 between the end points of a pre-plot is the reference for the output to a steering system. The end points comprises a starting point 3 and an end point 4, and the straight line there between is referred to the first straight line 2. The steering system would then output the constant desired survey line 10. The survey line 10 is an oscillating survey line 10 in this example arranged alternately on one side and on the other side of the first straight line 2. However the survey line 10 could be placed on one side of the first straight line 2. Top-points 11 of the curve is located alternately on one side and on the other side of the first straight line 2. The curved line/the survey line 10 is made in such a way that it is steadily rising until a top-point 11 and then is steadily decreasing/falling. However, the survey line 10 could also rise and fall, and rise and fall up to a top point.

An array of cross track offsets are provided at regular intervals along the first line 2. A number of offset straight lines 5 creates the cross track offsets, each offset line 5 being placed perpendicular to the first straight line 2. The offset lines 5 are each starting in a first point 6 placed on the first straight line 2 and ending in a second point 7 in a distance X from the straight line 2. The second points provide the array of cross track offset values, which are providing the survey line when connected continuous to each other.

In order to achieve a desired vessel movement, the desired track offset values are adjusted automatically based on the defined parameters. The cross track offset would implicitly be 0 meters at the end points. The acoustic pulses—provided for instance by shooting—generated during a previous survey—determine where the acoustic pulses in the present survey take place and thereby the cross track offset values. The shooting direction S is parallel with the first straight line 2.

In table 1 an example array of cross track offset values is provided:

TABLE 1

| Shot | Cross Track Offset |
|---|---|
| 1001 | 0 |
| 1002 | +1 |
| 1003 | +2 |
| 1004 | +3 |
| 1005 | +4 |
| 1006 | +5 |
| 1007 | +6 |
| 1008 | +7 |
| 1009 | +8 |
| 1010 | +8 |
| 1011 | +7 |
| 1012 | +6 |
| 1013 | +5 |
| 1014 | +4 |
| 1015 | +3 |
| 1016 | +1 |
| 1017 | 0 |
| 1018 | −2 |
| 1019 | −4 |
| 1020 | −6 |
| 1021 | −8 |
| 1022 | −9 |
| 1023 | −10 |
| 1024 | −11 |
| 1025 | −11 |
| 1026 | −10 |
| 1027 | −10 |
| 1028 | −8 |
| 1029 | −6 |
| 1030 | −4 |
| 1031 | −2 |
| 1032 | −1 |
| 1033 | +1 |
| 1034 | +2 |
| 1035 | +3 |
| 1036 | +5 |
| 1037 | +8 |
| 1038 | +9 |
| 1039 | +10 |
| 1040 | +10 |
| 1041 | +10 |
| 1042 | +9 |
| 1043 | +7 |
| 1044 | +5 |
| 1045 | +4 |
| 1046 | +3 |
| 1047 | +2 |
| 1048 | +1 |
| 1049 | 0 |

The first column is representing the shot point number, and the second column is the cross track offset value, which is the distance X value measured between the first point 6 and the second point 7 of the survey line 10. The desired track offset is the lateral and perpendicular distance of the survey line when compared to the straight line path between the two end points 3, 4 of the survey line. This can be positive or negative. A positive distance would imply that the desired survey line is to the starboard of the straight line path 2, a negative distance would imply that the desired survey line is to the port side of the straight line path 2.

The values are used for a steering algorithm such as algorithms built into seismic tracking modules connected to a vessel autopilot. Examples of such modules have trade names like Robtrack, Seistrack, KPOS. These provide a simplified interface for the seismic integrated navigation system (INS) to send commands to the vessel steering systems. The interface module between the INS and the seismic tracking modules is preferably a separate unit but may also be incorporated into the INS.

By the invention, the vessel steering systems are optimized to follow a path between the end points 3, 4 of the survey line 10 and to let the vessel 1 follow the curved path 10. The invention is applicable for 2D, 3D and advantageously for 4D surveys. This fact is due to changing currents, weather, and other environmental conditions, whereby the vessel and its towed equipment are not able to follow a straight line path.

In other words, instead of having a straight baseline path/survey line that we would have for a 3D survey line, we now have a new baseline/survey line, which is made up of a non-straight line path between the end points 3, 4 of the first straight line 2.

Table 2 shows what is referred to look-ahead cross track offset values. They may be provided by registering the length L of a streamer and the distance from the vessel to the seismic sources, and the distance from the vessel to the seismic streamers. Then an array/the numbers of acoustic pulses are calculated.

The reasoning behind the look ahead value is that the towed equipment is towed “behind” the vessel. This implies that there will be a delay between when the vessel passes a shot point of the survey line, and when the towed equipment passes that same shot point.

This so called “look-ahead algorithm” is a way to compensate for the delay between the vessel passing a shot-point with its desired “track offset” and the towed equipment passing the same shot-point. It may also be used to compensate for any inherent delays in the vessel steering systems.

For example, assuming that the towed source array is 225 meters behind the vessel, and we intend said towed source array to follow the desired track in preference to the vessel.

If there is 25 m between shot points on the survey line, then 225 meters equates to 9 shot points.

Therefore, we can arrange for the look-ahead algorithm/value to output the desired cross track offset to the seismic tracking module 9 shots before the vessel (or towed equipment) reaches that shot point, thereby allowing the vessel to induce steering commands, and cause the towed source to reach the desired lateral offset.

Table 2 shows an example of how the “look-ahead values” might work. Note how for shot-point number 1001, the look-ahead value is the cross track offset value from shot 1010 (9 shots later). For shot-point number 1002, the look-ahead value is the cross track offset value from shot-point 1011, etc.

The look ahead value could be generated in light of other conditions such as source distance from the vessel or streamer distance from the vessel. Since the towed equipment broadly follows the path of the vessel, the assumption is made that if we steer the vessel, then the equipment will follow some time later related to the distance the equipment is towed behind the vessel.

In other words, the look-ahead (time or distance) would be chosen to best match the combination (sum) of any steering delays and the distance from the vessel to the relevant part of the towed equipment.

This look-ahead “value” might change from survey to survey, or even potentially from line to line based on the real world behaviour of the vessel and towed gear system in those environmental conditions.

TABLE 2

| | Look-ahead values/ |
|---|---|
| Cross Track Offset | Predicted Offset |

| | | |
|---|---|---|
| 1001 | 0 | +8 |
| 1002 | +1 | +7 |
| 1003 | +2 | +6 |
| 1004 | +3 | +5 |
| 1005 | +4 | +4 |
| 1006 | +5 | +3 |
| 1007 | +6 | +1 |
| 1008 | +7 | 0 |
| 1009 | +8 | −2 |
| 1010 | +8 | −4 |
| 1011 | +7 | −6 |
| 1012 | +6 | −8 |
| 1013 | +5 | −9 |
| 1014 | +4 | −10 |
| 1015 | +3 | −11 |
| 1016 | +1 | −11 |
| 1017 | 0 | −10 |
| 1018 | −2 | −10 |
| 1019 | −4 | −8 |
| 1020 | −6 | −6 |
| 1021 | −8 | −4 |
| 1022 | −9 | −2 |
| 1023 | −10 | −1 |
| 1024 | −11 | +1 |
| 1025 | −11 | +2 |
| 1026 | −10 | +3 |
| 1027 | −10 | +5 |
| 1028 | −8 | +8 |
| 1029 | −6 | +9 |
| 1030 | −4 | +10 |
| 1031 | −2 | +10 |
| 1032 | −1 | +10 |
| 1033 | +1 | +9 |
| 1034 | +2 | +7 |
| 1035 | +3 | +5 |
| 1036 | +5 | +4 |
| 1037 | +8 | +3 |
| 1038 | +9 | +2 |
| 1039 | +10 | +1 |
| 1040 | +10 | 0 |
| 1041 | +10 | 0 |
| 1042 | +9 | 0 |
| 1043 | +7 | 0 |
| 1044 | +5 | 0 |
| 1045 | +4 | 0 |
| 1046 | +3 | 0 |
| 1047 | +2 | 0 |
| 1048 | +1 | 0 |
| 1049 | 0 | 0 |

FIGS. 3, 4 and 5 are detailed views of a part of the oscillating survey line 10 and different positions of a vessel 1. The reference numbers are the same as for FIGS. 1 and 2.

In FIG. 3, the vessel 1 is 6 m to the starboard of the straight line 2, which is the reference line for the seismic steering module. However, the desired location of the vessel 1 at this point is to be 10 m to the starboard of the straight line 2.

Therefore, in practical terms, the vessel 1 is currently 4 m out of position to the port of the curved line/the survey line 10.

When receiving this message, a seismic tracking module will see to that the autopilot steers further to starboard to try to reach the desired offset of 10 m.

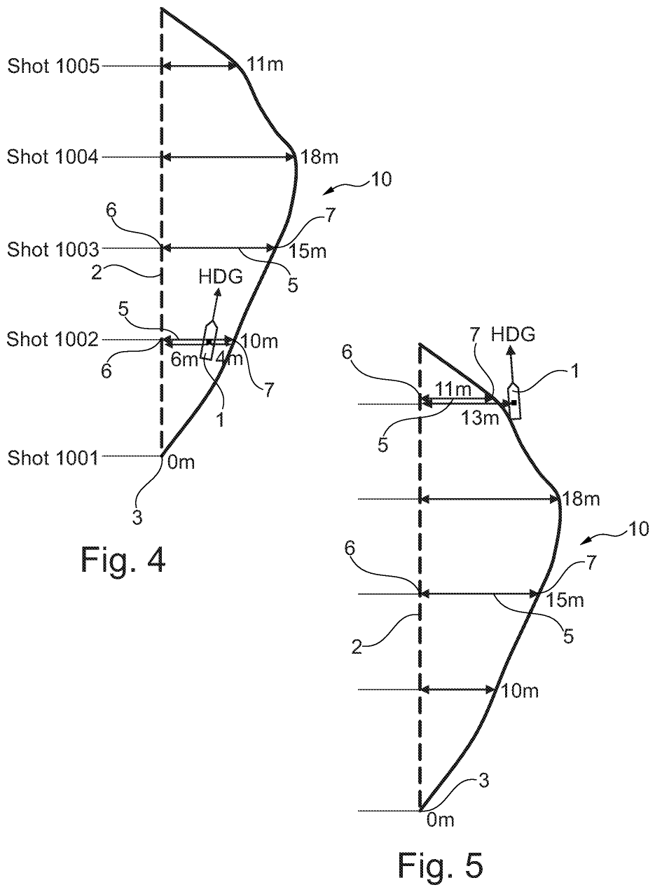

FIG. 4 is the same principle as FIG. 3, with the exception that the user has chosen to enter a manual “offset” of 4 meters. The main difference between the result of FIG. 3 and FIG. 4 is that in the circumstances in FIG. 4, the seismic tracking module would instruct the autopilot not to apply any rudder commands.

From these examples, it becomes clear that there are two discrete systems at work here. One is the seismic INS. This is a system designed for acquiring the seismic survey lines, and it controls when the source will be fired, and measures where the vessel and all of the towed equipment is located.

This system can send a request to the systems on the vessel's bridge to steer the vessel based only on the parameters defined.

The steering module provides:
A reference heading for the vessel track
The distance of the vessel from the desired track
Velocity in parallel to the desired track
Velocity perpendicular to the desired track
A desired offset for the vessel in relation to the track
A maximum allowed rate of turn for the vessel

The actual steering of the vessel is actioned by the seismic tracking module of the vessel steering systems on the bridge. This is an interface between the simple message sent from the INS, and the vessel's autopilot.

The method and the module according to the invention are an extension or modification of the INS, and the data it would provide in the message sent to the bridge systems.

The invention allows the INS to use a combination of predetermined cross track offsets, and user input to achieve a greater level of reliability and consistency.

In particular, existing implementations of the steering module within the INS cause irregular changes to the desired reference heading. The method proposed would instead provide a constant unchanging reference heading for the duration of the survey line.

In FIG. 5 the vessel 1 has effectively “overshot” the desired path and is 13 m from the straight line 2, or 2 m (starboard) of the desired track 10. This would cause the steering system to try to steer the vessel 1 more to port. Essentially, this would cause the vessel 1 to automatically be displaced more to the port towards the 11 meters.

1-9. (canceled)

10. A method for acquiring seismic data in a marine environment and for routing a vessel from a starting point to an end point, the vessel is towing seismic sources generating acoustic pulses and seismic receivers mounted to or inserted in streamers in the water following behind the vessel, whereby a survey of a marine environment area is generated, the method comprising:
generating a first straight line drawn from the starting point to the end point;
generating a number of offset straight lines, each offset line being placed perpendicular to the first straight line, and each starting in a first point placed on the first straight line, and ending in a second point in a distance X from the first straight line;
said second points providing an array of cross track offset values;
providing a curved and non-straight survey line when connected continuous to each other; and
said vessel is navigating by using the track offset values and substantially following the survey line.

11. The method according to claim 10, wherein the continuous connection-line between the arrays of cross track offset values provides an oscillating survey line arranged alternately on one side and on the other side of the first straight line or arranged at one side of the first straight line.

12. The method according to claim 10, wherein the array of cross track offset values are derived or calculated based on parameters for where and when acoustic pulses from a previous survey of the same marine environment area have been triggered,
and that the acoustic pulses during the present survey are intended to be triggered, when the tow vessel following the array of cross track offset values, or a towed equipment, are substantially reaching such a cross track offset value.

13. The method according to claim 10, wherein a deviation between the position of the tow vessel and the cross track off set values is overcome by changing the routing of the vessel by manual steering exercised by a user and automatically by an output to a vessel steering system.

14. The method according to claim 10, further comprising generating look-ahead cross track offset values based on a set of parameters for modelling a desired steering behaviour, the parameters comprise data including
registering the length L of a streamer,
registering the distance of the sources from the vessel,
registering the distance of the streamers from the vessel, and
said parameters are used to compute a look-ahead time or a look-ahead distance value, said values are used by a vessel steering system.

15. A vessel steering module for a seismic integrated navigation system (INS) adapted to send command information to a vessel steering system, wherein the command information is provided by data comprising:
determine the end-points of a baseline and use that to determine a desired first straight line between those points being a starting point and an end point,
generating a number of offset straight lines each offset line being placed perpendicular to the first straight line and each starting in a first point placed on the first straight line and ending in a second point in a distance from the first straight line,
determine the lateral and perpendicular distance between the first straight line derived in the previous step and the second point,
said second points derived from previous acoustic pulses generated during a previous survey, and adapted to be desired points for generating new acoustic pulses, and
store the parameters from the step above in an array or in a file for use by the vessel steering system, when acquiring a non-straight and curved survey line.

16. The vessel steering module according to claim 15, wherein the steering module further is configured to receive user-values said user-values are corrections to the cross track offset of the vessel based on local environments conditions.

17. The vessel steering module according to claim 16, wherein the vessel steering module is a separate module being an interface between the vessel steering module and another system such as a bridge control system.

18. Use of the vessel steering module according to claim 16 for performing the method according to claim 10.
